(19) United States
(12) Patent Application Publication
(10) Pub. No.: US 2010/0108579 A1
(43) Pub. Date: May 6, 2010

(54) Screening Machine with Segmented Components

(75) Inventors: Brady P. Ballman, Loveland, OH (US); Gerald Barth, Aurora, IN (US); Brian Blazer, Cincinnati, OH (US); Anthony Boberschmidt, Cincinnati, OH (US); James Potter, Harrison, OH (US); Douglas Steinriede, Cincinnati, OH (US)

Correspondence Address: WOOD, HERRON & EVANS, LLP, 2700 CAREW TOWER, 441 VINE STREET, CINCINNATI, OH, 45202, US

(73) Assignee: Rotex Global. LLC, Cincinnati, OH (US)

(21) Appl. No.: 12/261,117

(22) Filed: Oct. 30, 2008

(51) Int. Cl. B07B 1/49; B07B 13/04

(52) U.S. Cl. 209/659; 209/391; 209/320; 209/606

(57) ABSTRACT

A screen frame assembly is provided for use with a screening machine. The screen frame assembly includes first and second generally planar screen frames and a coupling between the first and second screen frames that includes a tab in the first screen frame and a receiving slot in the second screen frame. The receiving slot is configured to receive the tab and includes a centering feature for laterally aligning the first and second screen frames relative to one another. The centering feature may include a pair of opposed inwardly angled edges of the receiving slot. The coupling may include an overlap region between the first and second screen frames that is engageable to thereby permit lifting of the second screen frame by a lifting force exerted upon the first screen frame.

### TECHNICAL FIELD

This invention relates to screening machines or separators of the type used to separate or classify mixtures of solid particles of different sizes.

### BACKGROUND

In screening machines or separators of the type described, a screen (which may be woven, an aperture plate or another design) is mounted and pre-tensioned in what is often called a “screen frame” or “screen deck” that includes a supporting peripheral frame around the perimeter of the screen. The terms “screening machine” and “separator” and respective derivatives thereof are herein used interchangeably. A main housing of the screening machine supports one more of the screen frames, as well as agitating structures that shake or vibrate the solids deposited on the screen frames.

The screen frames are often removed from the screening machines for cleaning, replacement, readjustment or installation of a screen of a different mesh size or the like. In large commercial screening machines, the screen frames are inserted through and removed from a longitudinal end of the machine. In accordance with this movement of the screen frames, sufficient space must be devoted near the end of the machine, such that the generally horizontal screen frames may be inserted into and removed from the housing of the screening machine. Moreover, screen frames in large commercial screening machines tend to be relatively large, making their insertion and removal difficult or awkward at best, especially for a sole operator in tight working conditions.

Many machines of this type are used to separate particulate material which, over time, often clogs or blocks the screen frame mesh. Commonly, an agitating mechanism is included in the machine to unblock the mesh by dislodging the clogging material. Often, the agitating mechanism is a number of balls captured by a ball tray and accessible to the screen mesh. In large commercial screening machines, the agitating structures may be also inserted and removed respectively through the end of the machine, as described above with respect to the screen frames, thereby presenting similar space requirements. Moreover, known agitating structures tend to be large and relatively heavy, making their insertion into and removal from the housing of the screening machine a particularly difficult and work-intensive task for the operators involved.

It is evident, therefore, that a screening machine and screening machine components are needed that address these and other known problems associated with conventional screening machines.

### SUMMARY

In a first embodiment, a screen frame assembly is provided for use with a screening machine. The screen frame assembly includes first and second generally planar screen frames and a coupling between the first and second screen frames that includes a tab in the first screen frame and a receiving slot in the second screen frame. The receiving slot is configured to receive the tab and includes a centering feature for laterally aligning the first and second screen frames relative to one another. The centering feature may include a pair of opposed inwardly angled edges of the receiving slot. The coupling may include an overlap region between the first and second screen frames that is engageable to thereby permit lifting of the second screen frame by a lifting force exerted upon the first screen frame. The first and second screen frames may be juxtaposed to one another along respective confronting end portions thereof, and a seal member is disposed between the end portions. The seal member may be positioned between a top face of one of the screen frames and a bottom face of the other screen frame. The tab may be in the general form of a hook. Alternatively or additionally, the first and second screen frames may each include pre-tensioned screens. The receiving slot may be sized to accept a human finger there through.

In another embodiment, a screen frame assembly is provided for use with a screening machine. The screen frame assembly includes first and second generally planar screen frames, each having respective top and bottom faces and respective end portions adapted to overlap one another. A coupling between the screen frames is configured to permit movement of the first and second screen frames by a force that is exerted upon the first screen frame. A seal member is disposed at the end portions between the bottom face of the first screen frame and the top face of the second screen frame. The seal member may extend around substantially the entire second screen frame adjacent a perimeter thereof. The second screen may be mounted to the second screen frame via the seal member. The first and second screen frames may be substantially identical and interchangeable with one another.

In yet another embodiment, a screening machine includes a main housing and a screen frame assembly. The screen frame assembly has first and second generally planar screen frames and a coupling between the screen frames that is configured to permit movement of the first and second screen frames by a force that is exerted upon the first screen frame. The coupling includes a tab in one of the screen frames and a receiving slot in the other screen frame and which is configured to receive the tab. The receiving slot includes a centering feature for laterally aligning the first and second screen frames relative to one another. The screening machine also includes an agitating structure that is supported by the main housing and which is configured to hold a plurality of agitating elements from moving material that is held by the screen frame assembly.

The agitating structure may include a stopping element for restricting movement of the screen frame assembly relative to the agitating structure. At least one of the first and second screen frames may include a limiting tab that is engageable with the stopping element for selectively restricting movement of the first and second screen frames relative to the agitating structure. The agitating elements may include balls. The agitating structure may include first and second generally co-planar trays and a tray coupling between the first and second trays that is configured to permit movement of the first and second trays by a force that is exerted upon the first tray. The tray coupling may include a hook in one of the first and second trays that is engageable with a tray receiving slot of the other of the first and second trays. Alternatively or additionally, the first tray may include a tongue that is engageable with the first frame to restrict movement of the first frame relative to the first tray.

In another embodiment, a screening machine includes a main housing, a screen frame assembly, and an agitating structure that is supported by the main housing. The agitating structure is configured to hold a plurality of agitating elements for moving materials held by the screen frame assembly. The agitating structure includes first and second generally co-planar trays and a tray coupling between the first and second trays that is configured to permit movement of the first and second trays by a force exerted upon the first tray.

In another embodiment, a method is provided for moving screening components relative to a main housing of a screening machine. The method includes applying a force on a first of two generally planar screen frames, with such force moving the two screen frames relative to the main housing. A seal is positioned relative to overlapping portions of the two screen frames, and the first screen frame is moved relative to the other screen frame.

In embodiments having a screen frame assembly that is made up of two or more generally planar screen frames, insertion and removal of the screen frame assembly respectively into and out of the main housing of the screening machine is greatly facilitated. Similarly, in embodiments having an agitating structure that includes segmented co-planar trays, insertion and removal of the agitating structure is likewise facilitated.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a partially broken-away perspective view of a separator or screening machine in accordance with one embodiment of the invention;

FIG. 2 is a perspective view of a screen frame assembly and an agitating structure of the separator of FIG. 1;

FIG. 3 is a partially broken-away view of the screen frame assembly and the agitating structure of FIGS. 1 and 2 showing separation between two screen frames of the screen frame assembly;

FIG. 3A is an enlarged view of the encircled portion 3A of FIG. 3;

FIG. 3B is a view similar to FIG. 3A showing the screen frame therein in a position different from that shown in FIG. 3A;

FIG. 4 is a partially broken-away perspective view showing partial disengagement between the agitating structure and the screen frame assembly of FIGS. 2-3;

FIG. 4A is an enlarged perspective view of the encircled portion 4A of FIG. 4;

FIG. 4B is a cross-sectional perspective view taken generally along line 4B-4B of FIG. 4A;

FIG. 4C is a view similar to FIG. 4B showing disengaging motion between two screen frames of the screen frame assembly of FIGS. 2-3;

FIG. 4D is a view similar to FIGS. 4B and 4C showing the two screen frames being fully disengaged from one another;

FIG. 5 is a partially broken-away perspective view of the screen frame assembly of FIGS. 2-3 in inserting motion into the housing of the separator;

FIG. 5A is an enlarged view of the encircled portion 5A of FIG. 5;

FIG. 5B is a cross-sectional perspective view taken generally along line 5B-5B of FIG. 5A;

FIG. 5C is a perspective view similar to FIG. 5B showing the two screen frames of the screen frame assembly in relative positions different from those shown in FIG. 5B;

FIG. 6A is an enlarged perspective view of a stopping element and limiting tab of the separator of FIG. 1;

FIG. 6B is a view similar to FIG. 6A showing the limiting tab in a position different from that shown in FIG. 6A;

FIG. 7 is a partially broken-away perspective view similar to FIGS. 4 and 5 showing the two screen frames in an overlapping position;

FIG. 8 is a partially broken-away perspective view of the agitating structure of the separator of FIGS. 2-3;

FIG. 9 is a view similar to FIG. 8 showing two trays and a tray coupling of the agitating structure of FIG. 8;

FIG. 9A is an enlarged view of the encircled portion 9A of FIG. 9;

FIG. 9B is an elevational view of the tray coupling of FIG. 9A;

FIG. 9C is a view similar to FIG. 9B showing partial disengagement between two trays of the agitating structure of FIG. 9;

FIG. 9D is a view similar to FIG. 9C showing another relative position between the two trays different from that shown in FIG. 9C;

FIG. 9E is a view similar to FIGS. 9B-9D showing the two trays fully disengaged from one another;

FIG. 10A is an enlarged perspective view of a different embodiment of a tray coupling between two trays of an agitating structure;

FIG. 10B is an elevational view of the coupling structure shown in FIG. 10A;

FIG. 10C is a view similar to FIG. 10B showing two trays in partial disengagement from one another;

FIG. 10D is a view similar to FIGS. 10B and 10C showing the two trays in relative positions different from those shown in FIGS. 10B and 10C; and

FIG. 10E is a view similar to FIGS. 10B-10D showing the two trays fully disengaged from one another.

### DETAILED DESCRIPTION

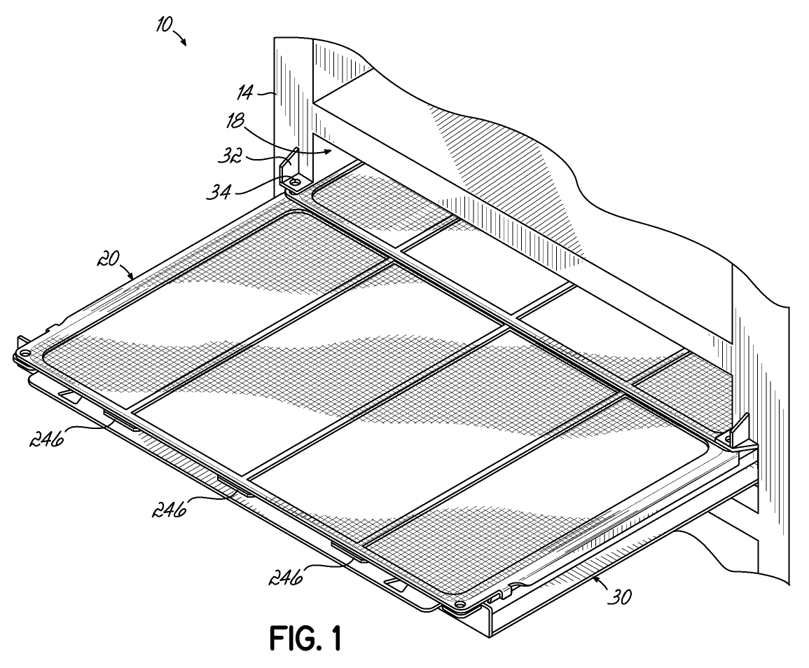

With reference to the figures, and more particularly to FIG. 1, a screening machine or separator 10 includes a main housing 14 having an access end 18 located at a longitudinal end of the housing 14 for inserting and removing screening components such as a screen frame assembly 20 and an agitating structure 30 cooperating with the screen frame assembly 20 to agitate or vibrate solids (not shown) deposited on the screen frame assembly 20. The main housing 14 includes a locking feature in the form of a pair of brackets 32 at the access end 18 and configured to receive a bolt or similar (not shown) through a hole 34 to secure the screen frame assembly 20 and agitating structure 30 within the main housing 14 and relative to one another.

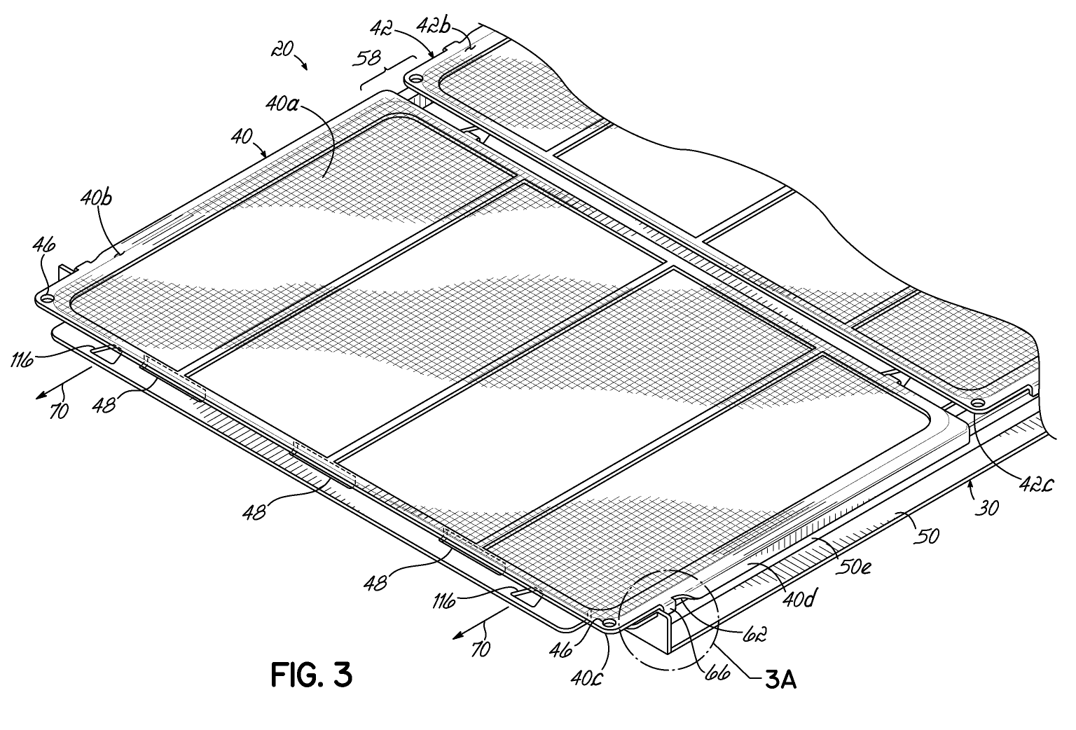

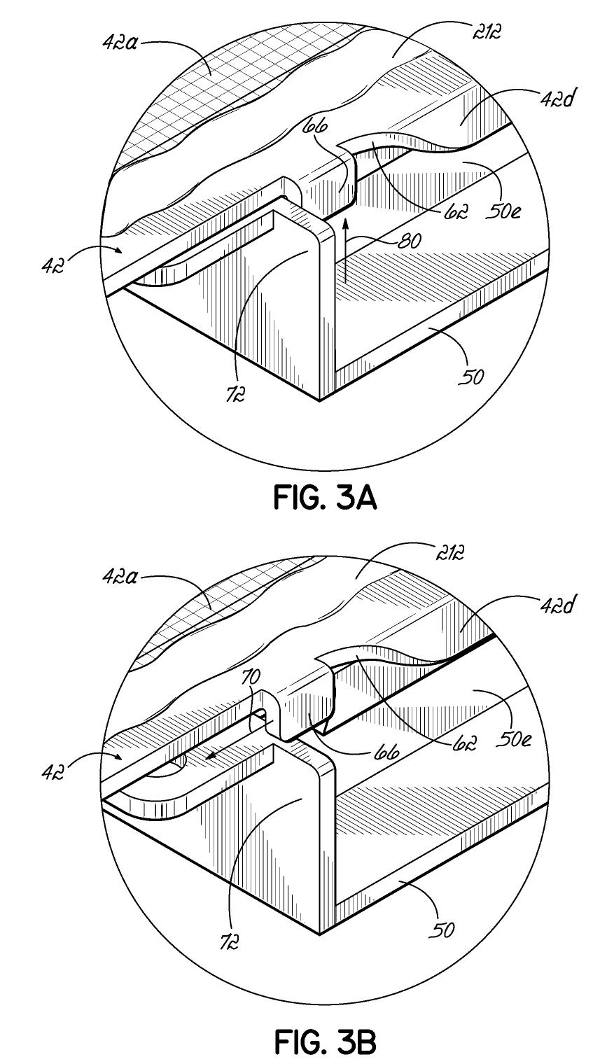

With reference to FIGS. 1-3, the screen frame assembly 20 of this exemplary embodiment is in the form of a segmented assembly that includes first, second and third generally planar screen frames 40, 42, 44 that are substantially identical to and interchangeable with one another. It is contemplated that the screen frame assembly 20 may instead have any number of screen frames other than three including, without limitation, a single screen frame, and still fall within the scope of the present disclosure. Each of the screen frames 40, 42, 44 includes several pre-tensioned screens 40a, 42a, 44a supported about the respective perimeters of the screen frames 40, 42, 44 and further includes a top face 40b, 42b, 44b and an opposite bottom face 40c, 42c, 44c. The screen frames 40, 42, 44 are engageable with one another to define overlap regions 58 between respective confronting ends of adjacent pairs of the screen frames 40, 42, 44. The overlap regions 58 prevent or at least minimize the likelihood of solids deposited on the screen frames 40, 42, 44 falling onto the underlying agitating structure 30. Each of the screen frames 40, 42, 44, moreover, includes a pair of holes 46 at respective front corners thereof, and which are designed to be in registration with the holes 34 of the brackets 32 of the main housing 14. These holes 46 are similarly configured to receive a bolt or similar element (not shown) there through to secure the screen frame assembly 20 relative to the main housing 14. Each of the screen frames 40, 42, 44 further includes a series of spaced apart grooves 48 (FIG. 3) along their respective front edges for securing the position of the screen frame assembly 20 relative to the underlying agitating structure 30, as explained in further detail below.

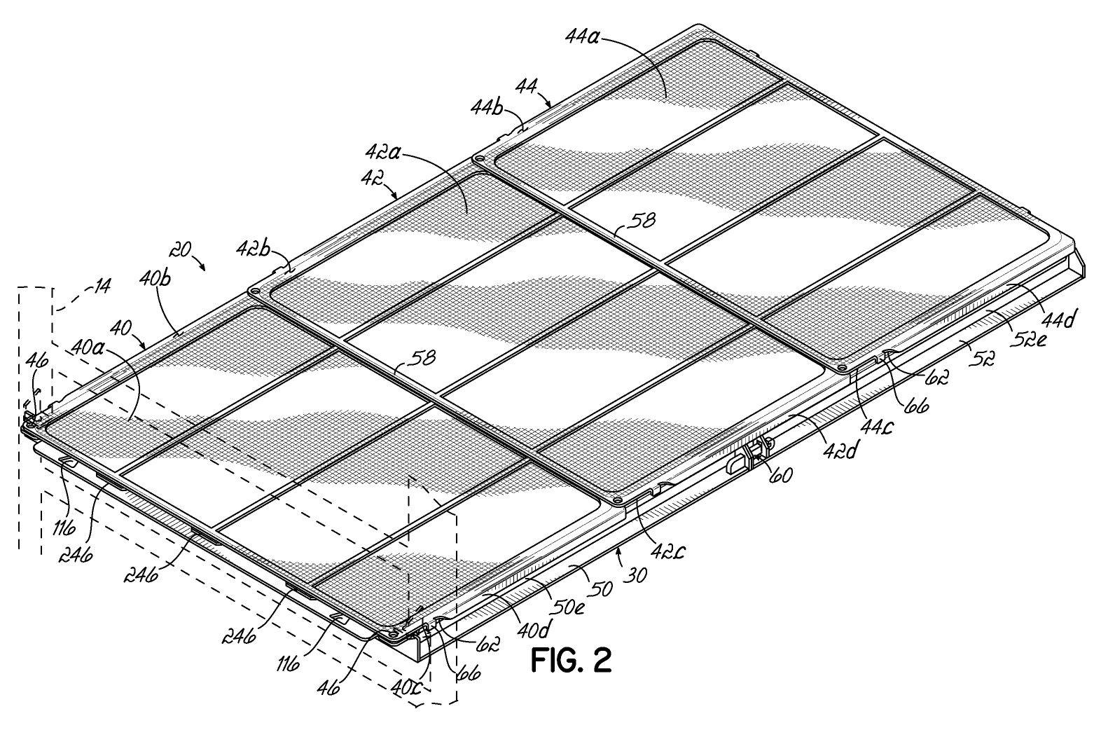

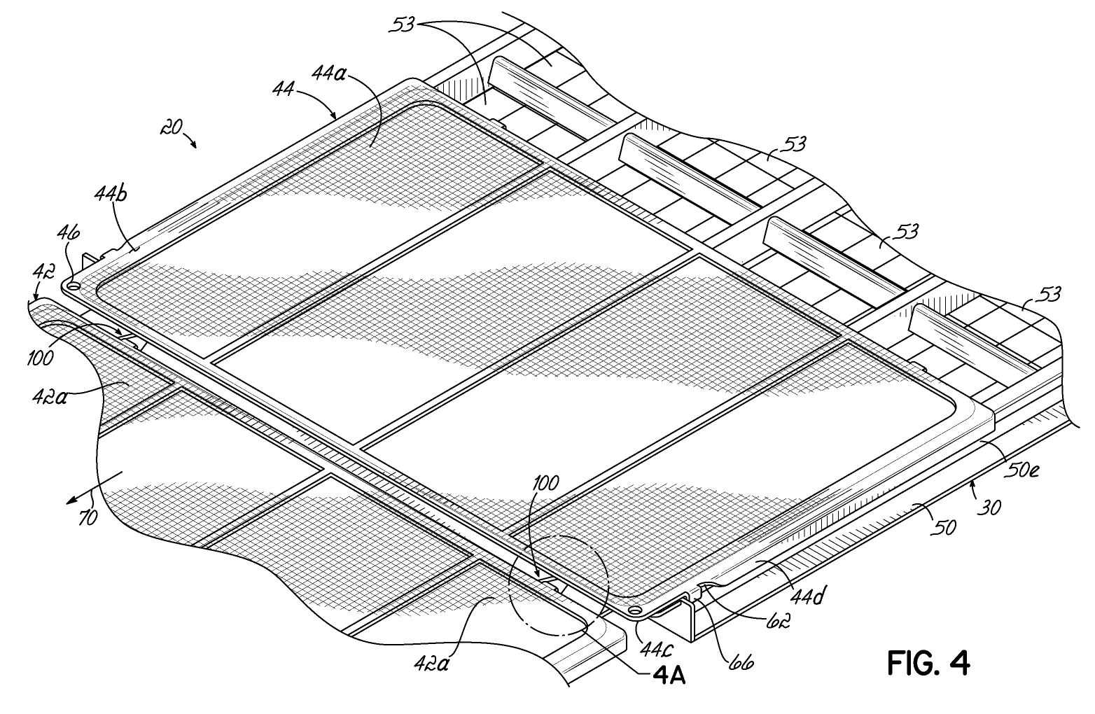

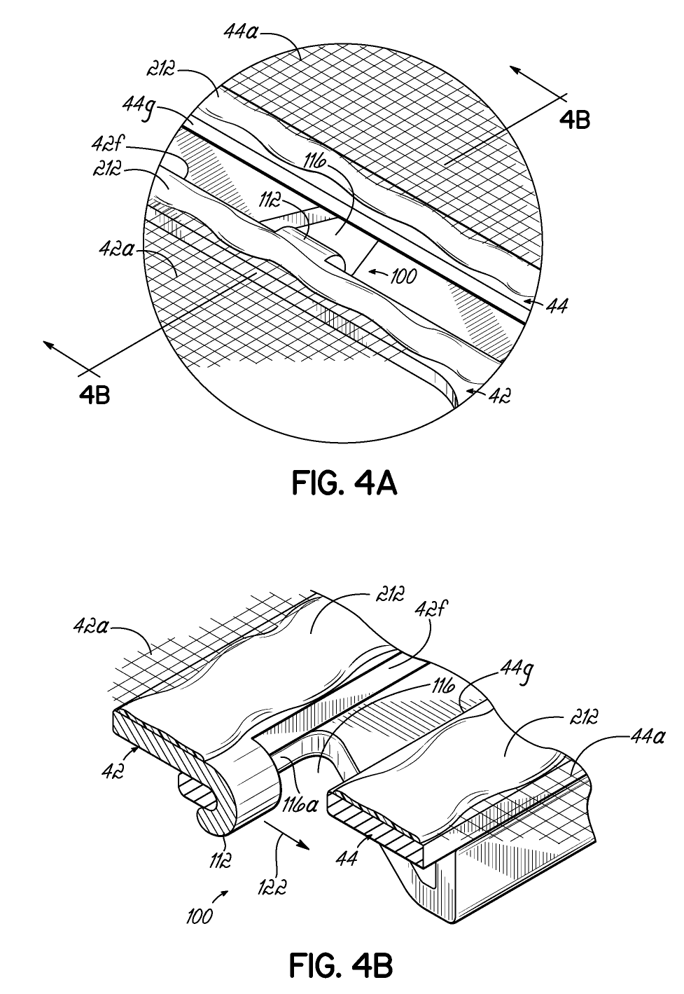

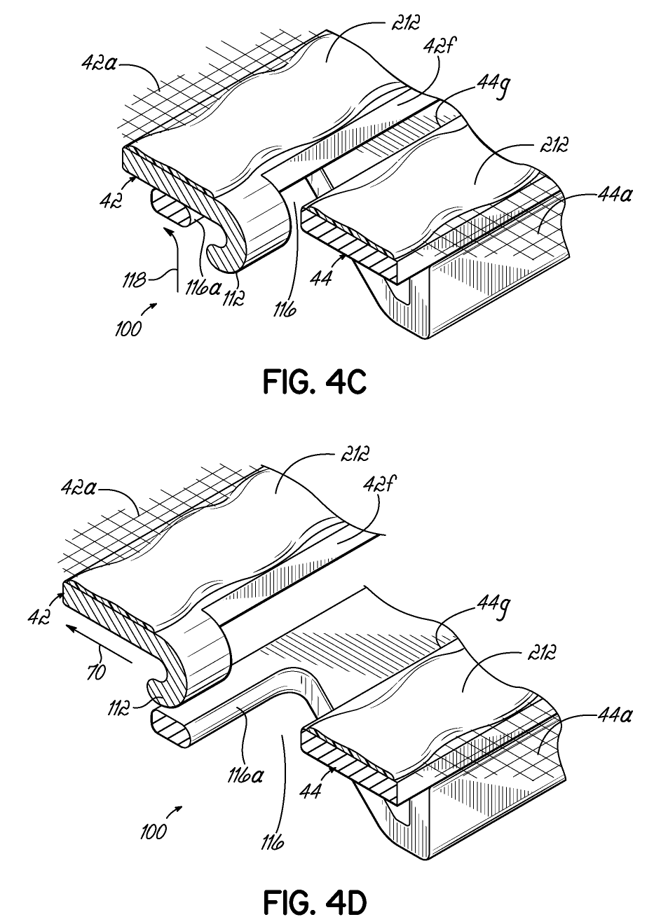

In this exemplary embodiment, the agitating structure 30 is in the form of a segmented tray assembly having first and second generally coplanar trays 50, 52 that are also engageable with one another through a tray coupling generally designated with the numeral 60. Each of the first and second trays 50, 52, in turn, in this exemplary embodiment, is partitioned into several compartments 53 (FIG. 4). Longitudinal lips 40d, 42d, 44d of each of the screen frames 40, 42, 44 engage the side walls 50e, 52e of the first and second trays 50, 52 and thereby determine a vertical position of the screen frames 40, 42, 44 relative to the trays 50, 52 when these are engaged with one another within the main housing 14 (shown in phantom in FIG. 2). Each of the longitudinal lips 40d, 42d, 44d extends only partially along the respective length of the screen frame 40, 42, 44 to define a gap 62 between each of the lips 40d, 42d, 44d and a limiting tab 66.

With reference to FIGS. 3, 3A, and 3B, the functionality of the limiting tabs 66 is described in further detail. FIG. 3 shows an exemplary removing motion of the screen frame assembly 20 from main housing 14 (FIGS. 1-2) and, more particularly, the removing motion of the first and second screen frames 40, 42. As the screen frame assembly 20 is pulled in the general direction of arrows 70, the screen frame assembly 20 is moved relative to the underlying agitating structure 30. This motion of the screen frame assembly 20 is such that the lip 40d of the first screen frame 40 rides over the side wall 50e of the underlying tray 50. This motion is stopped by engagement of the limiting tab 66 of the first screen frame 40 with a front end wall 72 of the tray 50. Any further removing motion of the screen frame 40 requires lifting of the first screen frame 40 in the general direction of arrow 80 (FIG. 3A) and subsequent continuation of the pulling motion (i.e., removing motion) of the first screen frame 40 in the general direction of arrows 70 (FIGS. 3 and 3B). Notably, the restriction of the removing motion of the first screen frame 40 provided by the engagement of the limiting tab 66 with the front end wall 72 provides a natural stopping point at which the operator is signaled to disengage the first screen frame 40 from the second screen frame 42 (FIG. 3), one manner of which is described in further detail below.

With reference to FIGS. 4, 4A, 4B, 4C, and 4D, an exemplary removing motion of the screen frame assembly 20 is depicted. In FIG. 4, the screen frame assembly 20 is illustrated in removing motion (arrow 70), moving away from the main housing 14 (FIGS. 1 and 2) and from the agitating structure 30. A coupling 100 between the second and third screen frames 42, 44 permits movement of the third screen frame 44 with the pulling force exerted on the second screen frame 42. More specifically, and with particular reference to FIG. 4A, the coupling 100 includes a generally hook-shaped tab 112 extending from the leading edge 42f of the second screen frame 42 that is received in and engages a generally trapezoidal-shaped receiving slot 116 in the trailing portion 44g of the third screen frame 44. As the second screen frame 42 is pulled in the general direction of arrow 70 (FIG. 4), the tab 112 engages a front edge 116a of the receiving slot 116 such that a pulling force applied on the second screen frame 42 results in pulling (i.e., removing motion) of both of the second and third screen frames 42, 44. Pulling of the second screen frame 42 is facilitated by the size and shape of the receiving slot 116, which is configured to receive at least one human finger there through to enable engagement of the finger with the second screen frame 42 and pulling thereof.

In operation, when engagement of the limiting tab 66 with the front end wall 72 of the agitating structure 30 occurs, the second screen frame 42 is disengaged from the third screen frame 44 as shown in the exemplary sequence illustrated by FIGS. 4B-4D. More specifically, the second screen frame 42 is first moved toward the main housing 14 (FIGS. 1-2) in the general direction of arrow 122 until the tab 112 reaches the general position shown in FIG. 4C. The operator then proceeds to tilt the second screen frame 42 relative to the third screen frame 44 in the general direction of arrow 118 (FIG. 4C), and then to remove the second screen frame 42 away from the third screen frame 44 in the general direction of arrow 70 (FIG. 4D).

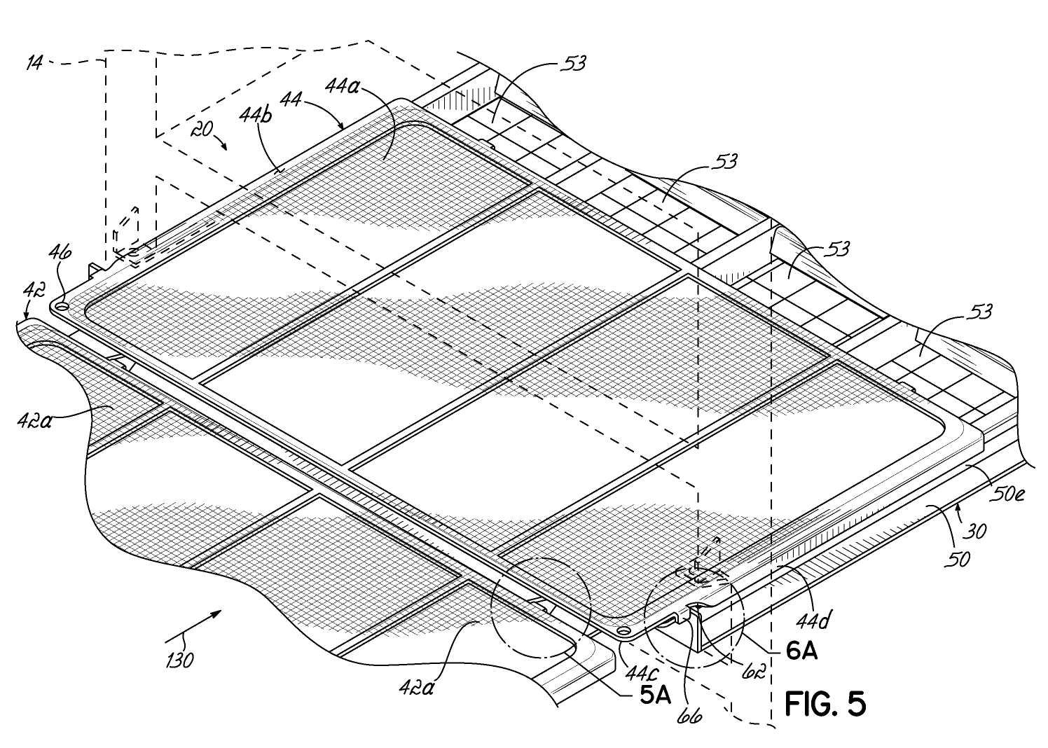

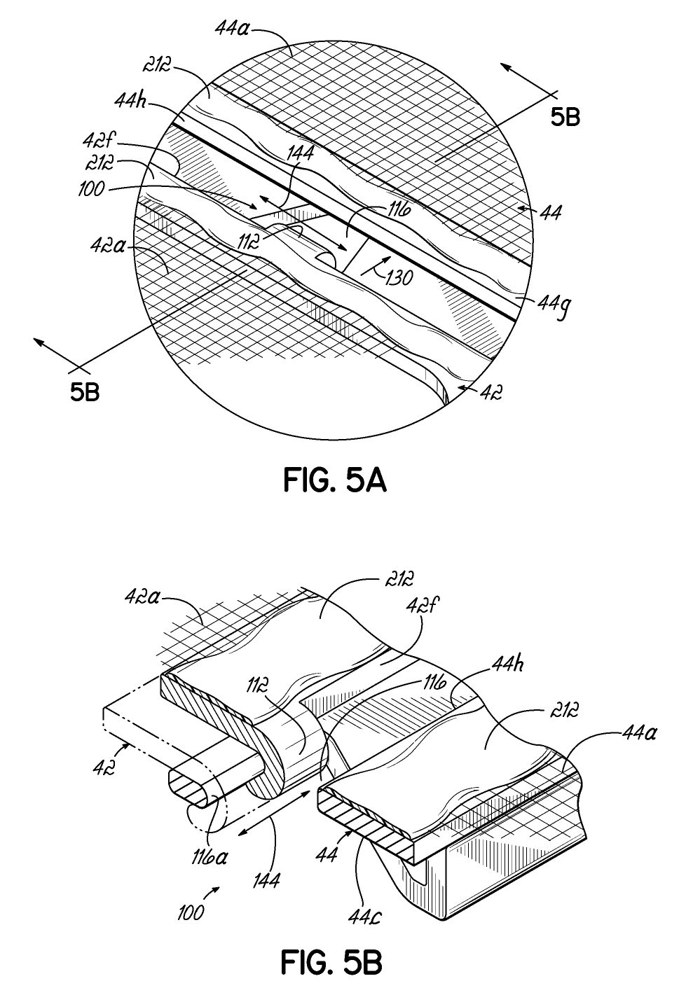

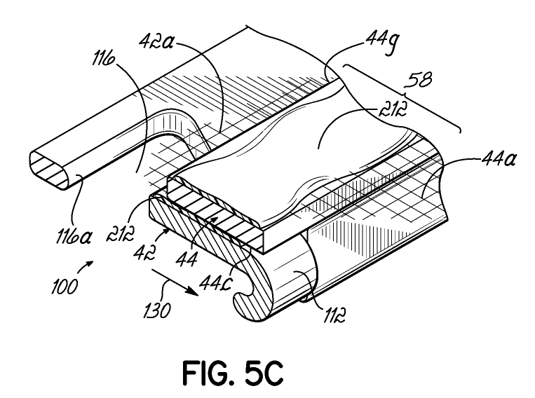

With reference to FIGS. 5, 5A, 5B, 5C, 6A, 6B, and 7, an exemplary insertion of the screen frame assembly 20 into the main housing 14 is illustrated. Inserting motion of the screen frame assembly 20 is effected in the general direction of arrow 130 and is such that an inserting force exerted onto the second screen frame 42 results in inserting movement of the second and third frames 42 and 44. With particular reference to FIGS. 5A-5B, the tab 112 of the second screen frame 42 is inserted within the receiving slot 116 of the third screen frame 44 and permitted to contact and engage the trailing edge 44h of the third screen frame 44, to thereby push the third screen frame 44 in the general direction of arrow 130. Notably, inserting movement (arrow 130) of the tab 112 within the receiving slot 116 is guided by a pair of inwardly angled lateral edges 116b of the receiving slot 116 such that lateral movement of the second screen frame 42 (arrow 144) is restricted. The guiding of the tab 112 within the receiving slot 116 thus defines a centering feature of the coupling 100 that aligns the second and third screen frames 42, 44 relative to one another. Moreover, the lateral edges 116b are also oriented downwardly to define an angle with the general plane of the third screen frame 44, as best appreciated in FIG. 5B.

FIG. 5C illustrates engagement of the tab 112 with the bottom face 44c of the third screen frame 44. This engagement of the tab 112 with the bottom face 44c permits a lifting force exerted upon the second screen frame 42 to similarly lift the third screen frame 44, as explained in further detail below. The engagement of the tab 112 with the bottom face 44c also permits the formation of the overlapping portion 58 between the second and third screen frames 42, 44 which, as discussed above, prevents or at least minimizes the passage of solid deposited on the screen frame assembly 20 to the underlying agitating structure 30 (FIGS. 1-2).

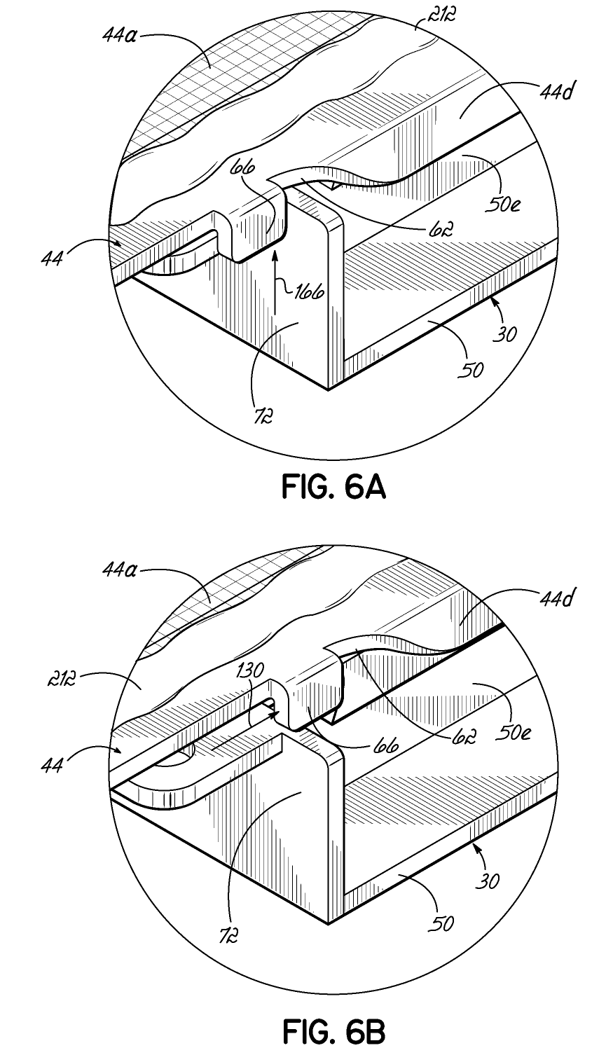

With particular reference to FIGS. 6A and 6B, the functionality of the limiting tab 66 and the gap 62 during the inserting motion of the screen frame assembly 20 (arrow 130) is illustrated in further detail with reference to the exemplary insertion of the third screen frame 44, though the same explanation is applicable to insertion of the other screen frames 40, 42 as well. The inserting motion is stopped when the limiting tab 66 of the third screen frame 44 engages the front end wall 72 of the tray 50 of agitating structure 30, as shown in FIG. 6A. In operation, the operator proceeds to exert a lifting force upon the third screen frame 44 in the general direction of arrow 166. This lifting force is applied onto the third screen frame 44 by an exertion of a lifting force onto the second screen frame 42 (FIGS. 5A-5C) and through the engagement of the tab 112 of the second screen frame 42 with the bottom face 44c of the third screen frame 44, as discussed above. When the limiting tab 66 of the third screen frame 44 clears the front end wall 72, as shown in FIG. 6B, the operator proceeds to continue with inserting motion of the second and third screen frames 42, 44 in the general direction of arrow 130, by exerting the pushing force onto the second screen frame 42, as also discussed above.

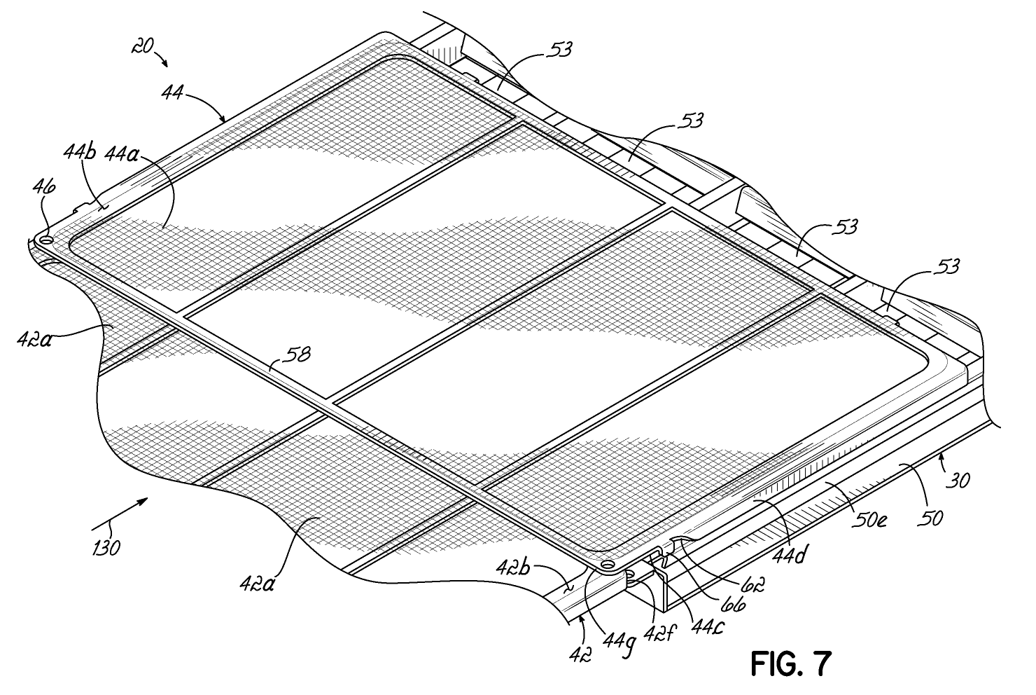

Referring now to FIG. 7, the second and third screen frames 42, 44 of the screen frame assembly 20 are shown in a fully engaged position. In this regard, the screen frames 42, 44 are shown having an overlapping portion 58. The overlapping portion 58 is defined, in this embodiment, by confronting end portions of the adjacent screen frames 42, 44. Thus, the overlapping portion 58 shown in FIG. 7 is formed from the juxtaposition of the bottom face 44c of the third screen frame 44 and the top face 42b of the second screen frame 42 where the leading edge 42f of the second screen frame 42 and the trailing edge portion 44g of the third screen frame 44 meet.

With continued reference to FIG. 7 and referring again to FIGS. 6A and 6B, each overlapping portion 58 includes a seal member 212 disposed between the respective top and bottom faces of the screen frames 40, 42, 44 at the confronting portions thereof. This position of the seal member 212 further prevents the passage of any solids deposited on the screen frame assembly 20 and onto the underlying agitating structure 30. Moreover, in this exemplary embodiment, the seal member 212 is disposed adjacent substantially the entire perimeter of each of the screen frames 40, 42, 44 and is enmeshed at least partially with the screens 40a, 42a, and 44a. In this regard, the exemplary seal member 212 of this embodiment also facilitates mounting of the screens 40a, 42a, 44a to their respective screen frames 40, 42, 44. In operation, the seal member 212 may be applied to a bottom face 40c, 42c, 44c of a screen frame 40, 42, 44 either substantially adjacent the entire perimeter of each of the screen frames 40, 42, 44 or just in the overlapping portion 58 between two adjacent screen frames 40, 42, 44 before the two adjacent screen frames 40, 42, 44 are engaged with one another. Similarly, when a screen frame 40, 42, 44 is removed from the main housing 14 (FIGS. 1-2), the seal member 212 is removed between each pair of adjacent screen frames 40, 42, 44 as part of the disengagement of adjacent screen frames 40, 42, 44 from one another. In one embodiment, the seal member 212 is a silicone or similar compound and described in U.S. Patent Application Publication No. US 2007/0125688, which is incorporated by reference in its entirety.

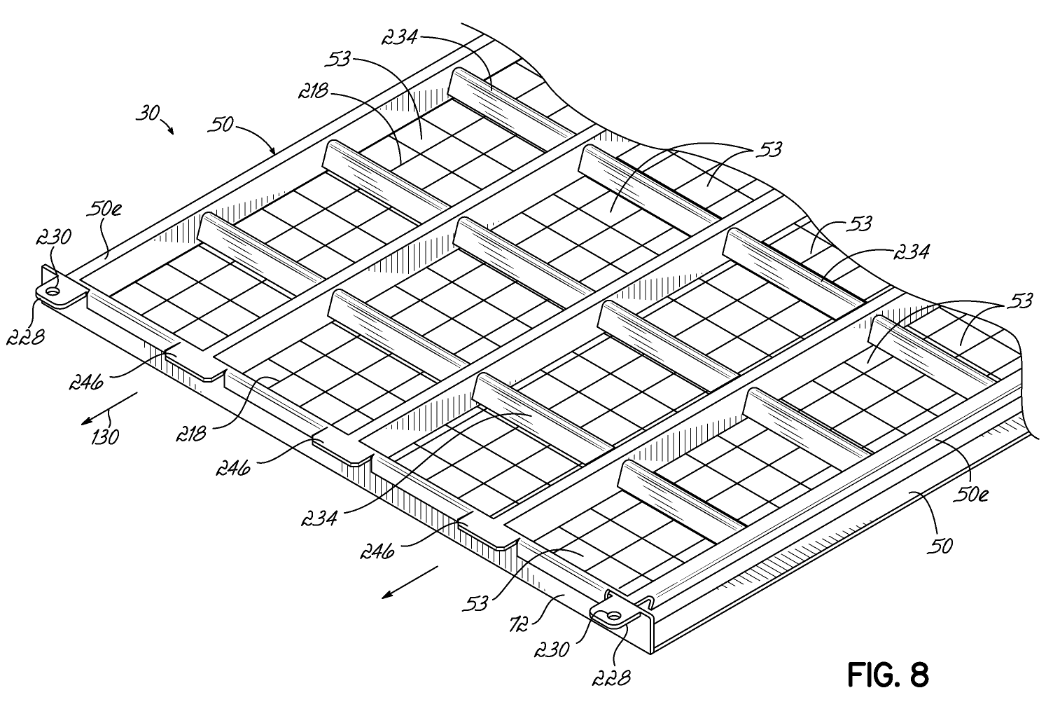

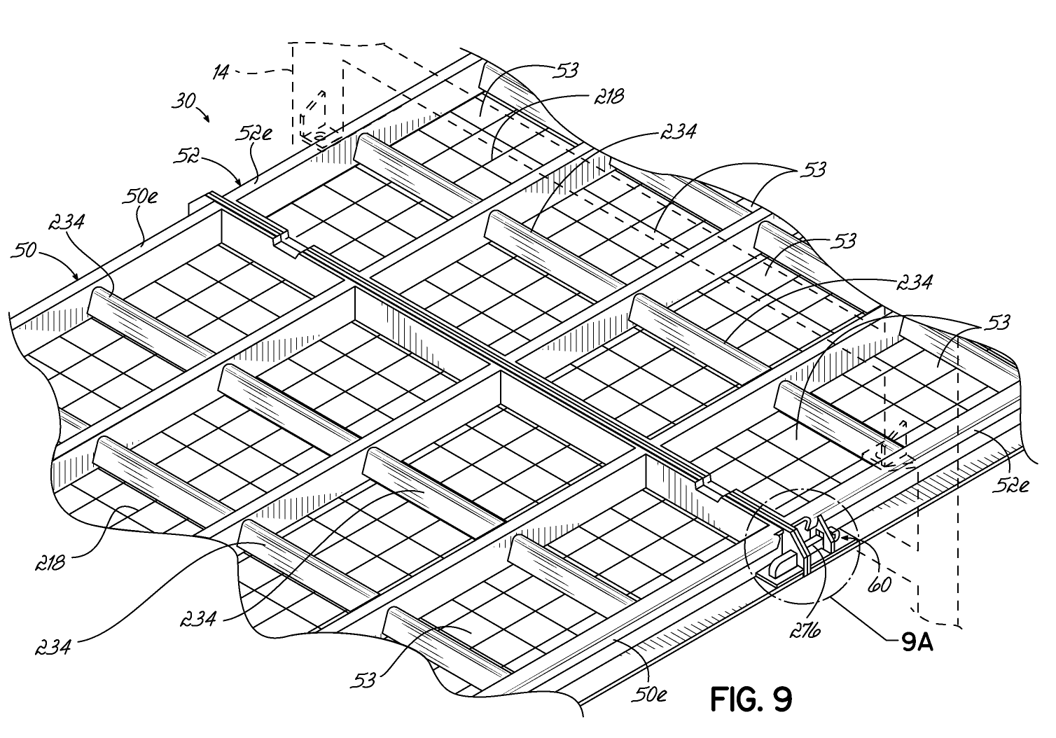

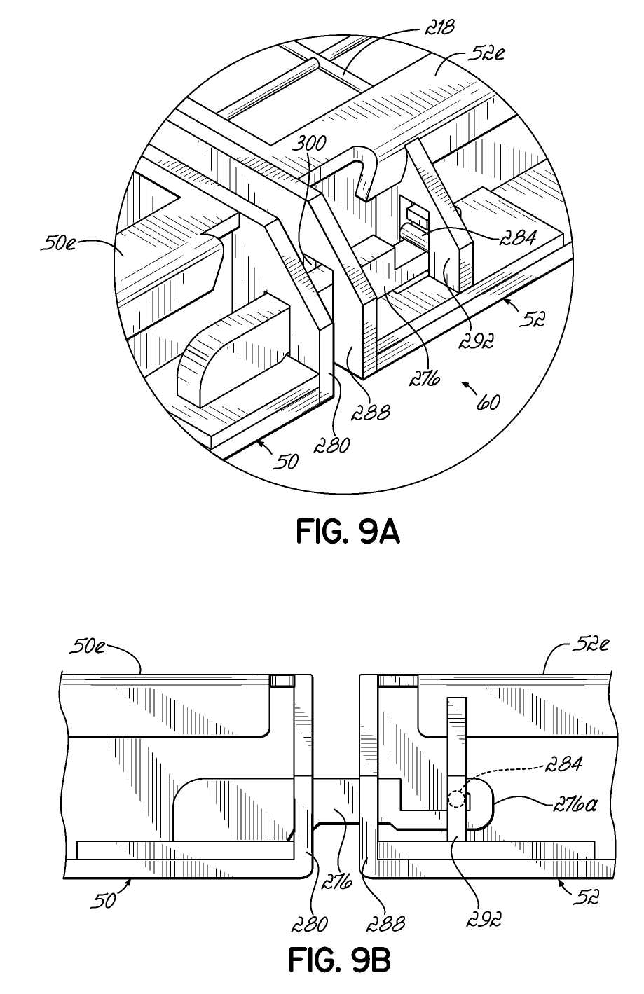

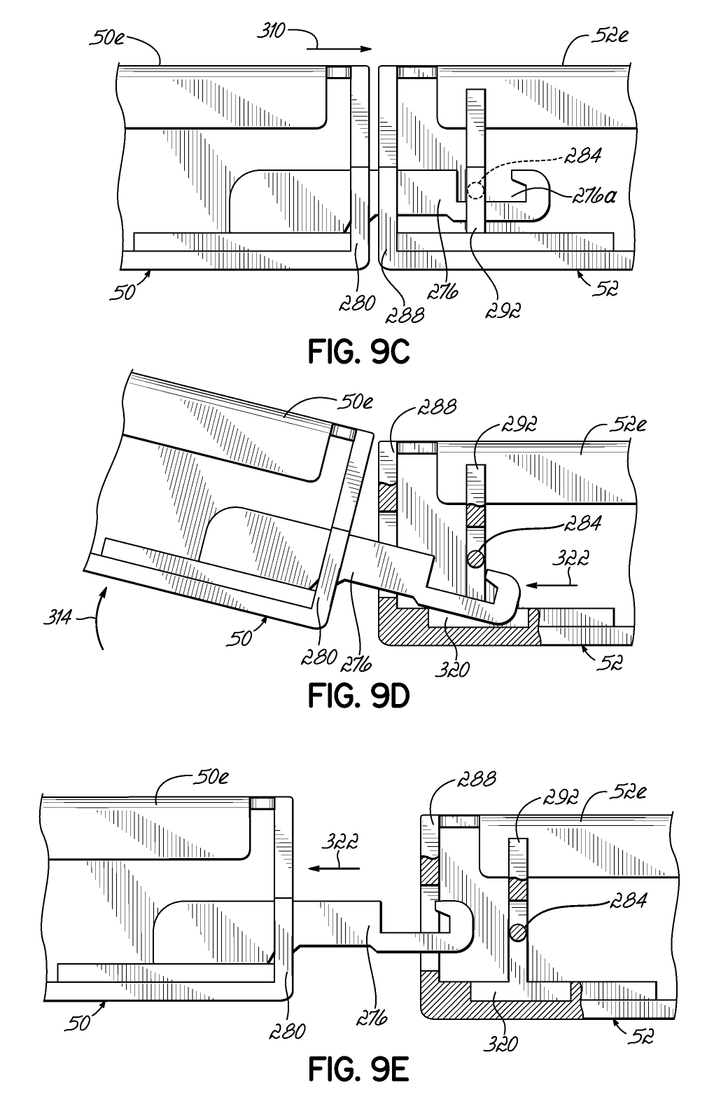

With reference to FIGS. 8, 9, 9A, 9B, 9C, 9D, and 9E, the agitating structure 30 is described in further detail. As discussed above, the agitating structure 30 in this exemplary embodiment is in the form of a segmented structure made up of individual trays 50, 52 engageable with one another through a tray coupling 60. It is contemplated, however, that an alternative agitating structure may have other shapes and/or include any number of trays other than the two trays of this exemplary embodiment. Such alternatives include, without limitation, an agitating structure having a single tray rather than a segmented tray assembly. Each of the individual trays of the illustrated embodiment includes several compartments 53 that hold agitating elements that move and thereby vibrate the solids deposited on the screen frame assembly 20. The agitating elements, although not shown, may for example and without limitation include balls made of metal, plastic or other suitable material and are held within the compartments 53. The agitating elements are supported by a support screen 218 and confined in the compartments 53 by partition walls 224, the side walls 50e, 52e, and longitudinally extending rails 228 defining the compartments 53.

A pair of securing brackets 228 extend from the front end wall 72 of the tray 50, adjacent the respective ends thereof, and cooperate with the brackets 32 of the main housing 14 (FIGS. 1-2) to permit securement of the agitating structure 30 within the main housing 14. To this end, each of the securing brackets 228 includes a hole 230 that is in registration with a corresponding hole 34 of each bracket 32 and which is similarly configured to receive a bolt or similar element (not shown) there through to thereby secure the agitating structure 30 relative to the main housing 14 (FIGS. 1-2). Moreover, because of the registration of the holes 34 of the brackets 32 with the holes 230 of the securing brackets 228 and the holes 46 of the screen frame assembly 20, the screen frame assembly 20 and the agitating structure 30 are both secured from movement relative to the main housing 14 (FIGS. 1-2).

With continued reference to FIGS. 8, 9, and 9A-9E, and further referring again to FIGS. 1 and 2, a series of tongues 246 extend from the front end wall 72 of the tray 50 and are spaced and sized to be received within the corresponding grooves 48 of the screen frame assembly 20. Accordingly, engagement of the tongues 246 with the grooves 48 permits further securing the position of the screen frame assembly 20 and agitating structure 30 relative to one another. This engagement is best illustrated in FIGS. 1 and 2.

With particular reference to FIGS. 9 and 9A-gE, details of the tray coupling 60 are further explained. The tray coupling 60, as discussed above, is configured to permit movement of the second tray 52 by a force exerted upon the tray 50. Accordingly, for example, an operator is able to pull both of the trays 50, 52 by exerting a pulling force on the first tray 50 and is further able to push both trays 50, 52 into the main housing 14 by exerting a pushing force on the first tray 50. The tray coupling 60 of this exemplary embodiment includes a finger in the general form of a hook 276 extending from a leading edge portion 280 of the first tray 50 that is engageable with a pin 284 adjacent a trailing end wall 288 of the second tray 52. More particularly, the pin 284 is inboard of the trailing end wall 288 and is supported at both ends thereof by a support plate 292 of the second tray 52. The trailing end wall 288 includes an aperture 300 that permits insertion of the hook 276 there through such that the hook 276 may reach the pin 284. In operation, accordingly, an operator pushes the first tray 50 relative to the second tray 52, permitting the hook 276 to travel through the aperture 300 and under the pin 284. To this end, and although not shown, the operator would tilt the first tray 50 relative to the second tray 52 to allow a generally U-shaped portion 276a of the hook 276 to wrap around the pin 284, as illustrated in FIG. 9B. When the hook 276 is thus engaged with the pin 284, any pulling force exerted on the first tray 50 results in a corresponding pulling force exerted by the generally U-shaped portion 276a on the pin 284, thereby resulting in movement of the second tray 52 as well. In this embodiment, moreover, the generally U-shaped portion 276a is sized to closely surround the pin 284 such that relative vertical movement between the first and second trays 50, 52 is at least minimized. The tray coupling 60, moreover, permits pushing motion (into the main housing 14) of both trays 50, 52 by a pushing force exerted onto the first tray 50. More particularly, the insertion of the hook 276 through the aperture 300 and under the pin 284 is configured to permit the abutment of the confronting end walls 280, 288 of the first and second trays 50, 52, respectively, as shown in FIG. 9, such that any pushing force exerted onto the first tray 50 is transmitted through contact between the end walls 280, 288 onto the second tray 52.

Disengagement of the first and second trays 50, 52 from one another is best explained with particular reference to the exemplary sequence illustrated in FIGS. 9C-9E. A step in the disengagement sequence includes the operator moving the first tray 50 forward (i.e., into the main housing 14) relative to the second tray 52, as shown in FIG. 9C, in the general direction of arrow 310. This relative forward movement of the first tray 50 permits, as shown, partial disengagement of the hook 276 from the pin 284. A subsequent step in the disengagement process includes tilting the first tray 50 upward relative to the second tray 52, as shown in FIG. 9D, in the general direction of arrow 314, to permit the generally U-shaped portion 276a of the hook 276 to clear the pin 284. More specifically, the portion 276a is partially received within a recess 320 at the base of the support plate 292 to permit clearing movement of the portion 276a relative to the pin 284. An operator then exerts a pulling force on the first tray 50, in the general direction of arrow 322, to complete the disengagement process of the first and second trays 50, 52, as illustrated in FIG. 9E.

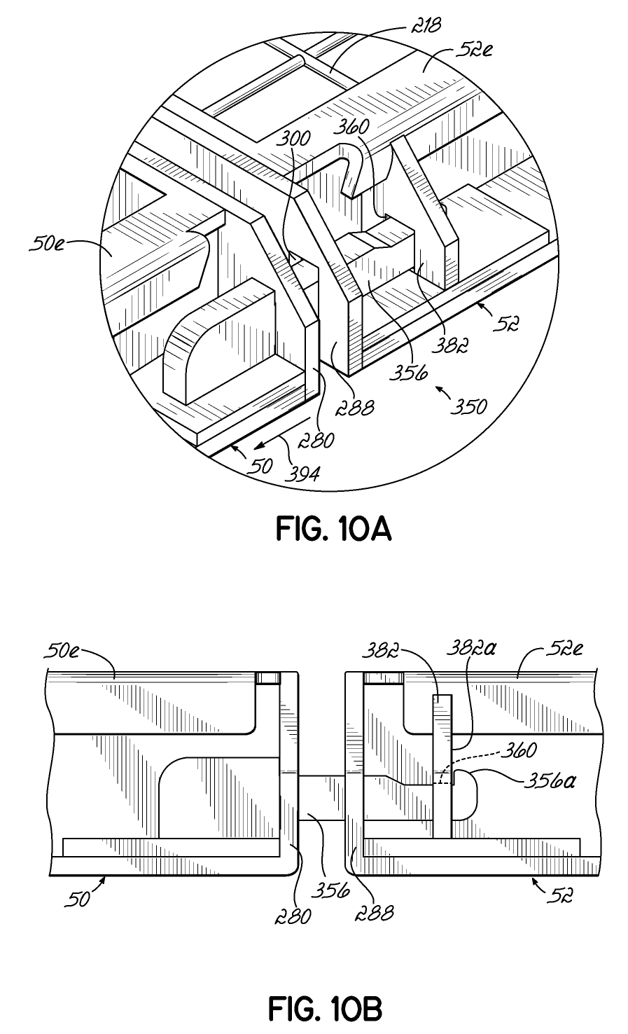

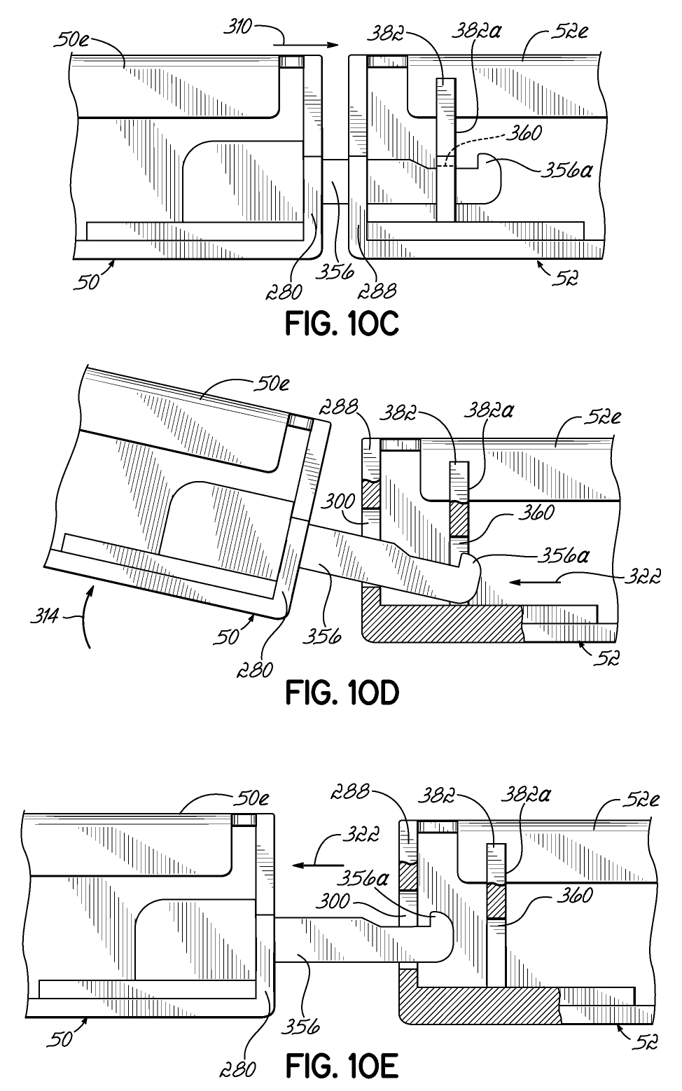

With reference to FIGS. 10A, 10B, 10C, 10D, and 10E, an alternative embodiment of a tray coupling 350 is illustrated. For ease of understanding, like reference numerals in FIGS. 10A-10E refer to like features of the preceding figures. The tray coupling 350 includes a finger 356 that has a distal portion shaped differently from the portion 276a of the hook 276 (FIGS. 9A-9E) and which is received through an aperture 360 of a plate 382 situated similarly to the support plate 292 of the tray coupling 60 of FIGS. 9A-9E. When the finger 356 is received through the aperture 360, an upwardly oriented portion 356a of the finger 356 engages the back surface 382a of the plate 382, thereby preventing removing motion (arrow 394) of the first tray 50 relative to the second tray 52. Accordingly, a pulling force in the general direction of arrow 394 applied onto the first tray 50 results in a corresponding removing motion of both, the first and second trays 50, 52.

Disengagement of the first and second trays 50, 52 having the alternative tray coupling 350 is best explained with particular reference to the exemplary sequence illustrated in FIGS. 10C-10E. A step in such disengagement sequence includes the operator moving the first tray 50 forward (i.e., into the main housing 14) relative to the second tray 52, as shown in FIG. 10C, in the general direction of arrow 310. This relative forward movement of the first tray 50 permits, as shown, partial disengagement of the finger 356 from the back surface 382a of the plate 382. A subsequent step in the disengagement process includes tilting the first tray 50 upward relative to the second tray 52, as shown in FIG. 10D, in the general direction of arrow 314, to permit the upwardly oriented portion 356a of the finger 356 to clear the plate 382 through the aperture 360. An operator then exerts a pulling force on the first tray 50, in the general direction of arrow 322 to complete the disengagement process of the first and second trays 50, 52, as illustrated in FIG. 10E.

From the above disclosure of the general principles of the present invention and the preceding detailed description of at least one preferred embodiment, those skilled in the art will readily comprehend the various modifications to which this invention is susceptible. Therefore, we desire to be limited only by the scope of the following claims and equivalents thereof.

What is claimed is:

1. A screen frame assembly for use with a screening machine, comprising:
first and second generally planar screen frames; and
a coupling between said screen frames including a tab in said first screen frame and a receiving slot in said second screen frame configured to receive said tab, said receiving slot including a centering feature for laterally aligning said first and second screen frames relative to one another.

2. The screen frame assembly of claim 1, wherein said centering feature includes a pair of opposed inwardly angled edges of said receiving slot.

3. The screen frame assembly of claim 2, wherein said angled edges further define an angle relative to a plane of said second screen frame.

4. The screen frame assembly of claim 1, wherein said coupling includes an overlap region between said first and second screen frames engageable to thereby permit lifting of said second screen frame by a lifting force exerted upon said first screen frame.

5. The screen frame assembly of claim 1, wherein said first and second screen frames are juxtaposed to one another along respective confronting end portions thereof, a seal member being disposed between said end portions.

6. The screen frame assembly of claim 5 wherein said seal member is positioned between a top face of one of said first and second screen frames and a bottom face of the other of said first and second screen frames.

7. The screen frame assembly of claim 1, wherein said tab is in the general form of a hook.

8. The screen frame assembly of claim 1, wherein said first and second screen frames each further comprise pre-tensioned screens.

9. The screen frame assembly of claim 1, wherein said receiving slot is sized to accept a human finger there through.

10. A screen frame assembly for use with a screening machine, comprising:
first and second generally planar screen frames, each having respective top and bottom faces and respective end portions adapted to overlap one another;
a coupling between said screen frames configured to permit movement of said first and second screen frames by a force exerted upon said first screen frame; and
a seal member disposed between adjacent portions of the screen frames.

11. The screen frame assembly of claim 10 wherein said seal member is disposed at said end portions between said bottom face of said first screen frame and said top face of said second screen frame.

12. The screen frame assembly of claim 10 further comprising:
first and second pre-tensioned screens mounted on said first and second screen frames, respectively, said seal member being enmeshed with a portion of said second screen.

13. The screen frame assembly of claim 12 wherein said seal member extends around substantially the entire second screen frame adjacent a perimeter thereof.

14. The screen frame assembly of claim 13 wherein said second screen is mounted to said second screen frame via said seal member.

15. The screen frame assembly of claim 14 wherein said first and second screen frames are substantially identical and interchangeable with one another.

16. A screen frame assembly for use with a screening machine, comprising:
first and second generally planar screen frames, said first screen frame including a leading edge; and
a coupling between said screen frames configured to permit movement of said first and second screen frames by a force exerted upon said first screen frame, said coupling including a tab in said first screen frame and a receiving slot in said second screen frame configured to receive said tab, said tab configured to engage a bottom face of said second screen frame to thereby permit lifting of said second screen frame by a lifting force exerted upon said first screen frame.

17. The screen frame assembly of claim 16 further comprising:
a centering feature for laterally aligning said first and second screen frames relative to one another.

18. A screening machine comprising:
a main housing;
a screen frame assembly having first and second generally planar screen frames and a coupling between said screen frames configured to permit movement of said first and second screen frames by a force exerted upon said first screen frame, said coupling including a tab in one of said first and second screen frames and a receiving slot in the other of said first and second screen frames and configured to receive said tab, said receiving slot including a centering feature for laterally aligning said first and second screen frames relative to one another; and
an agitating structure supported by said main housing and configured to hold a plurality of agitating elements for moving material held by said screen frame assembly.

19. The screening machine of claim 18, wherein said agitating structure includes a stopping element for restricting movement of said screen frame assembly relative to said agitating structure.

20. The screening machine of claim 19, wherein at least one of said first and second screen frames includes a limiting tab engageable with said stopping element for selectively restricting movement of said first and second screen frames relative to said agitating structure.

21. The screening machine of claim 18, wherein said agitating elements include balls.

22. The screening machine of claim 18, wherein said agitating structure includes first and second generally coplanar trays and a tray coupling between said first and second trays configured to permit movement of said first and second trays by a force exerted upon said first tray.

23. The screening machine of claim 22, wherein said tray coupling includes a hook in one of said first and second trays engageable with a tray receiving slot of the other of said first and second trays.

24. The screening machine of claim 22, wherein said first tray includes a tongue engageable with said first frame to restrict movement of said first frame relative to said first tray.

25. A screening machine comprising:
a main housing;
a screen frame assembly; and
an agitating structure supported by said main housing and configured to hold a plurality of agitating elements for moving materials held by said screen frame assembly, said agitating structure including first and second generally coplanar trays and a tray coupling between said first and second trays configured to permit movement of said first and second trays by a force exerted upon said first tray.

26. A screening machine comprising:
first and second generally planar, substantially identical and interchangeable screen frames, each having at least one pre-tensioned screen; and
a coupling between said first and second screen frames including a tab in the general form of a hook and projecting from a portion of said first screen frame and a receiving slot in said second screen frame configured to receive said tab and sized to accept a human finger there through, said tab engageable with a bottom face of said second screen frame to permit lifting of said second screen frame by a lifting force exerted upon said first screen frame, said receiving slot including a centering feature for laterally aligning said first and second screen frames relative to one another;
wherein:
said centering feature includes a pair of opposed inwardly angled edges of said slot,
said first and second screen frames are juxtaposed to one another along respective confronting end portions thereof, a seal member being disposed between said end portions and positioned between a top face of one of said first and second screen frames, and a bottom face of the other of said first and second screen frames and extending around substantially the entire second screen frame adjacent a perimeter thereof, and
said coupling between said first and second screen frames permits forward and backward movement of said first and second screen frames by a force exerted upon said first screen frame.

27. A method of moving screening components relative to a main housing of a separator, the method comprising:
applying a force on a first of two generally planar screen frames, the force moving the two screen frames relative to the main housing;
positioning a seal relative to overlapping portions of the two screen frames; and
moving the first screen frame relative to the other of the two screen frames.
